(19) United States
(12) Patent Application Publication
(10) Pub. No.: US 2006/0152683 A1
(43) Pub. Date: Jul. 13, 2006

(54) Cooling fan with embedded light source

(76) Inventor: Ya-Shin Lee, Taipei (TW)

Correspondence Address: LIN & ASSOCIATES INTELLECTUAL PROPERTY, P.O. BOX 2339, SARATOGA, CA, 95070-0339, US

(21) Appl. No.: 11/035,234

(22) Filed: Jan. 13, 2005

(51) Int. Cl. G03B 21/18; G03B 21/26; G03B 21/14; G03B 21/22

(52) U.S. Cl. 353/57

(57) ABSTRACT

A cooling fan with embedded light source is disclosed, which has an impeller, a fan motor, a circuit board, multiple bond wires and light emitting devices enclosed within the frame body which is composed of an upper half and a lower half. The lower frame has multiple dividers arranged in a radial pattern which forms three troughs radiates outward toward the circular wall. One trough and one wire slot joined by the same line hold a bond wire, and one header slot holds a light emitting device. This arrangement allows the bond wires and the light emitting devices to be well protected from the outside environment when the cooling fan is finally assembled, and the light from the light emitting devices can be easily spotted by a computer user to quickly diagnose the operating conditions of the cooling fan.

### BACKGROUND OF THE INVENTION

1. Field of the Invention

The present invention relates to a cooling fan with embedded light source, and in particular to a cooling fan that is capable of using light emission during the computer operation to quickly diagnose the current state of the cooling fan installed in the computer.

2. The Related Art

In general, the CPU, the mainboard, and the host of other components inside the computer can produce heat when the power of the computer is turned on. One or more cooling fans are often installed in the computer to ventilate the hot air trapped inside the computer casing. If the heat inside the casing increases, at a certain point, the high temperature inside the computer casing may cause the breakdown of the computer components.

Conventionally, a cooling fan is mounted inside a molded frame, with an impeller and a fan motor attached thereon. The fan motor is connected by electrical wires to the same power source used by the computer that houses the cooling fan. When the power switch of the computer is turned on, the stator core and the rotor plates are activated, and then the impeller is in action to generate air flow in the enclosed space of the computer to ventilate the hot air inside the computer. As a result, the temperature from the operation of the computer can be reduced and remains steady within a safety range.

Lately, many stylish casing with dazzling lights to emphasis the modernistic forms and shapes are designed by case manufacturers to attract the young generation. Some case manufacturers put the light emitting devices inside the cooling fan to produce a flickering light when the computer is activated.

The reason why the case manufacturers use light emitting devices in a cooling fan is to use the light emission to indicate the operation status of the fan inside the casing, and serve as a quick indicator in monitoring the computer status, and the flickering light can be easily spotted by the computer user without the use of sophisticated instruments. As long as the flickering light is seem through the blades, a computer user can reasonably assure that the cooling fan is working normally. If such light source is not utilized, a computer user will have to rely on sophisticated instruments to determine whether the cooling fan is working or not. In general, the use of temperature sensors can only reflect the resultant temperature data gathered from the computer components. To have a thorough check, the computer casing may have to be removed to further examine the internal components inside. Therefore, the use of light emitting devices in the cooling fan allows the computer users to diagnose the current condition of the fan inside the computer quickly without using sophisticated instruments.

The current practice of some case manufacturers is to have the light emitting devices installed behind the blades of the impeller. When the impeller rotates, the light beam of the light emitting devices is partially blocked by the rotating blades and produces a flickering light. The computer user therefore can quickly detect if the cooling stops, by simply watching the light emitted from the light emitting devices. Once the condition of the cooling fan can be determined, the user can reasonably estimate whether the operating temperature of the computer is within the safety range, otherwise a shutdown is necessary to further check the internal components more closely.

With reference to FIGS. 5 and 6, the conventional assembly of a cooling fan with light emitting devices is shown. Because of low power consumption, the light emitting devices, or light emitting diodes (LEDs), are usually installed along the inner surface of a flexible band B, which surrounds the perimeter of the frame body A. To assemble the cooling fan, a stator core 4 with a flexible band is first attached onto the external frame A. Then, multiple LEDs 6 are each installed through a hole A1 on the inner surface of the frame body A to penetrate the circular wall of the frame body, and each terminal end is secured on the flexible band. This LED arrangement allows the terminals of the LEDs 6 to be electrically connected to the circuit board 5 located at the bottom of the stator core 4 by using external wiring. Then, the impeller 3 is installed on the stator core 4 to complete the conventional assembly of the cooling fan. However, this conventional assembly of the cooling fan leaves the electrical wires and the flexible band exposed outside the frame body, so the appearance of the cooling fan is not well organized.

### SUMMARY OF THE INVENTION

The primary objective of the present invention is to conceal the exposed electrical wires of a cooling fan with embedded light source after the assembly, and thus preclude shoddy assembly of a flexible band around the external frame to secure the light emitting devices.

In accordance with the first aspect of the present invention, the structure of the frame body is designed to have an upper half and a lower half, so an impeller, a fan motor, a circuit board, multiple bond wire and light emitting devices can be enclosed within an inner space after the upper and lower halves of the frame body are put together. This structural design protects the above components better from the exterior environment.

In accordance with the second aspect of the invention, multiple dividers are arranged on the base of the lower frame in a radial pattern, and every two of the dividers are paired to form a trough, which is joined by a wire slot and an header slot through the wall of the lower frame, whereby one of the troughs and one of the wire slots joined by the same line are used to hold a bond wire, and an header slot is to hold the light emitting device attached to the head end of the bond wire. Using this structural design, the light emitting devices and the bond wires can be concealed inside the cooling fan, and the external surface of the cooling fan is neat and well organized.

In accordance with the third aspect of the invention, multiple vertical pins are built to extend downward from the lower edge of the upper frame and to be inserted into corresponding wire slots on the lower frame, when the two halves of the frame body are joined together. These vertical pins are used to shut off the opening of the wire slots for securing the bond wire.

In accordance with the fourth aspect of the invention, multiple notches are built on the lower frame to latch up the snap hooks on the upper frame. When the upper and lower halves are joined, the snap hooks are engaged in the notches to place the upper and lower frame in an interlocking position. The use of the snap hooks makes the assembly procedure very convenient without the use of screws.

In accordance with the fifth aspect of the invention, the frame body is made of transparent synthetic materials, which can enhance the dazzling effect of the light beams of the light emitting devices and make the cooling fan even more noticeable.

With the accompanying drawings, which show the preferred embodiment of the present inventions, the following description of the present invention will be easier to understand.

### BRIEF DESCRIPTION OF THE DRAWINGS

FIG. 1 is the exploded assembly drawing of a cooling fan with embedded light source in accordance with the present invention;

FIG. 2 is the perspective view of an assembled cooling fan in accordance with the present invention;

FIG. 3 is the drawing shows the arrangement of light emitting devices and bond wires on the base before the final assembly;

FIG. 4 is a sectional drawing shows the interlocking structure of a snap hook and a notch along the A-A sectional line taken out from FIG. 2;

FIG. 5 is the exploded assembly drawing shows the structure of a conventional cooling fan with light emitting devices attached; and

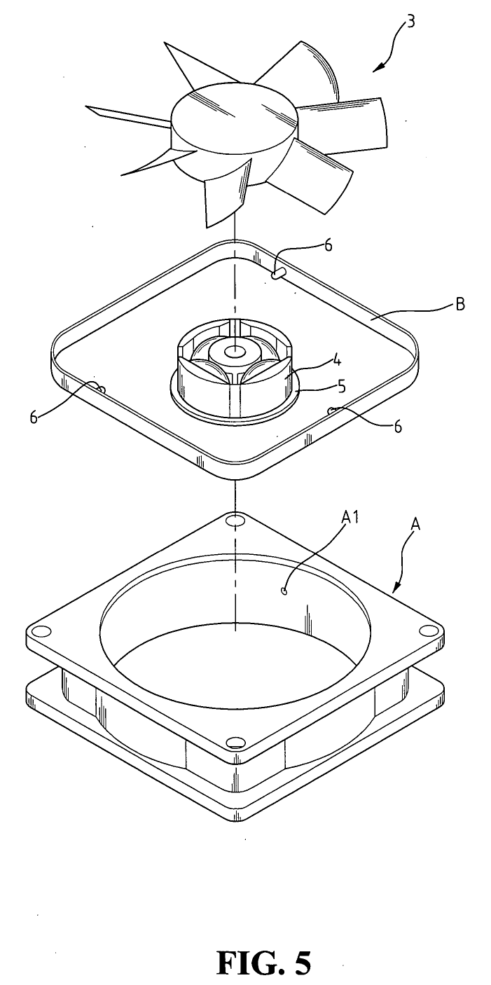

FIG. 6 is the perspective view of the conventional assembly of a cooling fan.

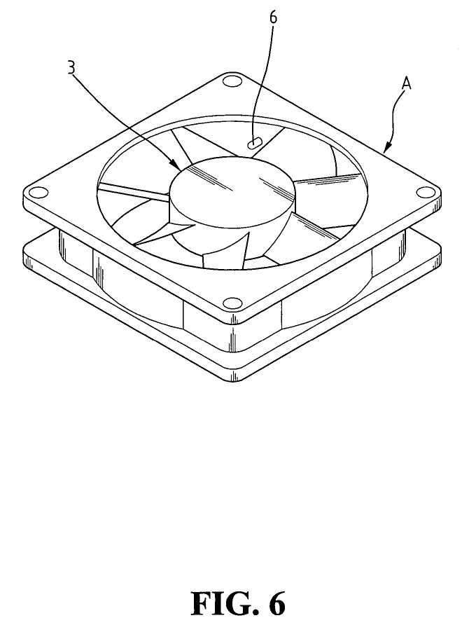

### DETAILED DESCRIPTION OF THE PREFERRED EMBODIMENT

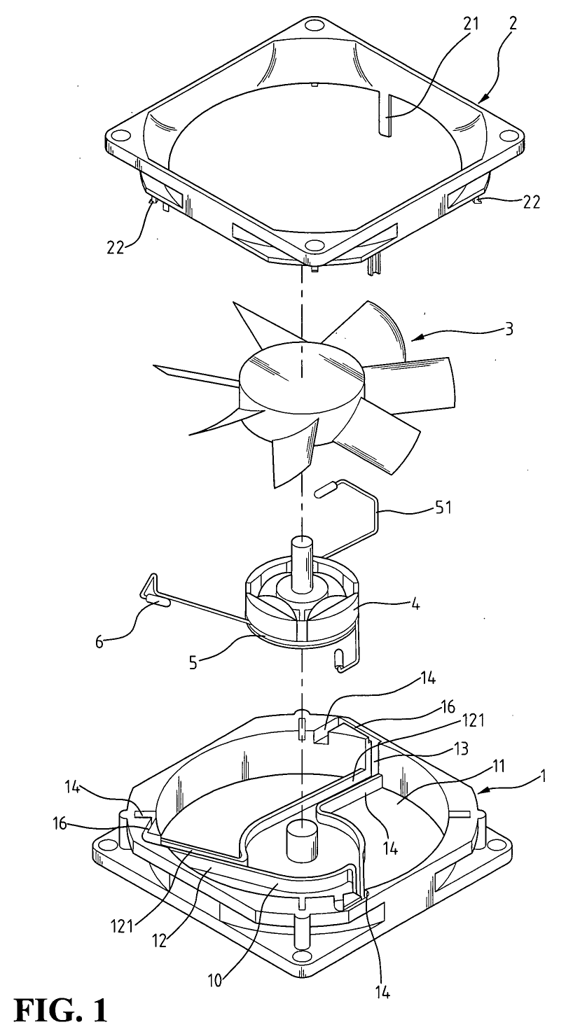

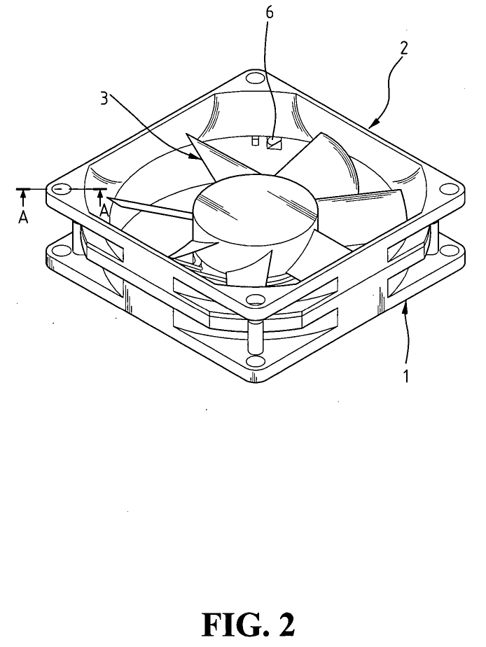

Referring to FIG. 1, the frame body of the cooling fan in accordance with the present invention is composed of an upper frame 2 and a lower frame 1, wherein the height of the lower frame 1 is higher than that of the upper frame 2 in order to accommodate an impeller 3, a fan motor 4 and a circuit board 5 within the inner space 11 of the cooling fan. The lower frame 1 has a stator core 4 installed on a base 10 of the lower frame 1, and multiple dividers 12 surround the stator core 4 that radiates outward toward the circular wall of the lower frame 1. Every two of the dividers are paired to form a trough 121, which is connected by a wire slot 11 and a header slot 14 cut through the surface of the circular wall. One of the troughs 121 and one of the wire slots 12 connected by the same line and used to hold a bond wire, while the header slot 14 is to hold the light emitting device attached to the head end of the bond wire. Referring to FIG. 2, one end of the header slot 14 is open to the inner space 11, so the light beams emitted from the light emitting devices can be easily spotted by a computer user through the blades. The lower frame 1 also has multiple notches 15 built at the appropriate locations of the circular wall, as part of an interlocking mechanism.

Referring to FIG. 1, the upper frame 2, which has a structure complementary to the lower frame 1, has multiple vertical pins 21 built on the lower edge that extends downward. The vertical pins 21 shall be inserted into corresponding wire slots 14 on the lower frame 2 when the two complementary frames are joined together. The upper frame 2 also has multiple snap hooks 22 at four corners of the lower portion to connect with notches 15 on the lower frame 2 when the two complementary frames are joined together.

Still referring to FIG. 1, the stator core 4 is placed on a circuit board 5 with an axle erecting therefrom. During the final assembly of the cooling fan, the impeller 3 shall be installed on the stator core 4.

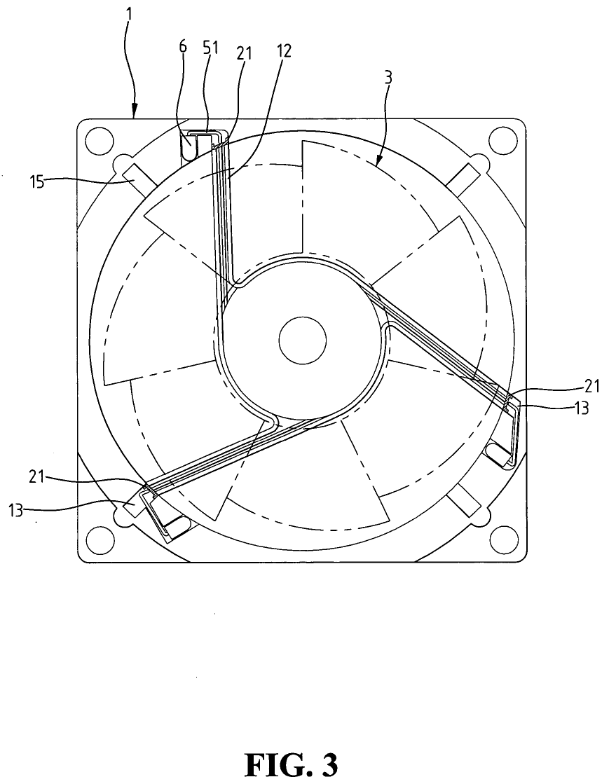

Referring to FIG. 3, the circuit board 5 is connected by multiple bond wires 51 which extend outward from the center, and each of these bond wires has a light emitting device 6 attached to the head end, where the light emitting device can be light emitting diode (LED) for the low power consumption characteristics.

In accordance with the assembling procedures of the present invention, The stator core 4 is first placed on the base 10 of the lower frame 1, and then a bond wire 51 is placed in corresponding to the trough 121. The bond wire 51 leads to a header slot 14, where a light emitting device 6 is attached. The light emitting device 6 faces the inner space 11 after the installation, and then the impeller 3 is inserted onto the axle of the stator core 4 on the circuit board 5, so that light emission from the light emitting devices can be easily spotted through the blades when the cooling fan is finally assembled. An assembled cooling fan is shown in FIG. 2.

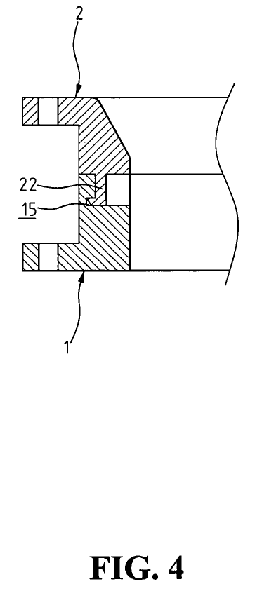

Referring to FIGS. 3 and 4, the vertical pins 21 extend downward from the lower edge of the upper frame 1 shall be inserted into respective wire slots 13 on the lower frame 2 to shut off the openings of the wire slots 13 (as shown in FIG. 3). The snap hooks 22 at the corners of the upper frame 2 shall be inserted into corresponding notches 15 on the lower frame 2 (as shown in FIG. 4) to bind the upper and lower frames together. The design of the vertical pins 21 and the snap hooks 22 allows a cooling fan to be assembled easily. Since the bond wires 51 and the light emitting devices 6 are enclosed within the frame body, the external surface of the cooling fan is well organized.

To further enhance the visual effect of the casing, the frame body in accordance with the present invention is made of transparent synthetic materials. Although the light emitting devices 6 are embedded in the frame body, the light from the light emitting devices 6 can be easily seen from the outside because the diffraction of light creates a dazzling effect.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A cooling fan with an embedded light source, an impeller, a stator core, a circuit board, multiple bond wires and light emitting devices enclosed in a frame body, the frame body comprising:
a lower frame which has multiple dividers arranged on a base, whereby every two of the dividers are paired to form a trough in a radial pattern, where the trough is joined by a wire slot and a header slot along the same line, respectively used for holding a bond wire and a light emitting device attached at the head end of the bond wire; and
an upper frame which has a structure complementary to the lower frame;
wherein the stator core, circuit board, bond wires and light emitting devices are first installed on the base of the lower frame before a final assembly of the impeller, lower and upper frames to complete a cooling fan.

2. The cooling fan as claimed in claim 1, wherein the upper frame has multiple vertical pins built on the lower edge which extend downward, and the pins shall be inserted into corresponding wire slots on the lower frame to shut off the openings of the wire slots.

3. The cooling fan as claimed in claim 2, wherein the lower frame has multiple notches built on the circular wall, and the notches shall be locked against the snap hooks of the upper frame when the two complementary frames are put together.

4. The cooling fan as claimed in claim 1, wherein the header slots are cut through the surface of the circular wall, and one end is open to the inner space of the lower frame.

5. The cooling fan as claimed in claim 2, wherein the header slots cut through the surface of the circular wall, and one end is open to the inner space of the lower frame.

6. The cooling fan as claimed in claim 3, wherein the header slots cut through the surface of the circular wall, and one end is open to the inner space of the lower frame.

7. The cooling fan as claimed in claim 1, wherein the upper and lower frames are made of transparent synthetic materials.

8. The cooling fan as claimed in claim 2, wherein upper and lower frames are made of transparent synthetic materials.

9. The cooling fan as claimed in claim 3, wherein upper and lower frames are made of transparent synthetic materials.
